(19) United States
(12) Patent Application Publication
(10) Pub. No.: US 2007/0257893 A1
(43) Pub. Date: Nov. 8, 2007

(54) Touch Screen

(75) Inventors: Harald Philipp, Southampton (GB); Keith Britton, Southampton (GB); Matthew Trend, Southsea (GB)

Correspondence Address: DAVID KIEWIT, 5901 THIRD ST SOUTH, ST PETERSBURG, FL, 33705, US

(73) Assignee: Harald Philipp, Southampton (GB)

(21) Appl. No.: 11/737,934

(22) Filed: Apr. 20, 2007

Related U.S. Application Data
(60) Provisional application No. 60/746,176, filed on May 2, 2006.

(51) Int. Cl. G06F 3/041

(52) U.S. Cl. 345/173

(57) ABSTRACT

A touch-sensitive sensor comprises a control circuit board and a sensor substrate which are fixed to a cover panel. Electrical connection terminals on the sensor substrate are adjacent an edge of the circuit board. To establish electrical connections between the sensor substrate and control circuitry on the circuit board, sprung electrical connectors are provided. These are mounted on the side of the circuit board opposite the side which is fixed to the cover panel. This allows the circuit board to be fixed flat against the control panel. The sprung electrical connectors are configured to extend over the edge of the control circuit board and are bent towards the control panel so that they resiliently connect with the connection terminals of the sensor substrate. This allows electrical connections to be established automatically as the sensor substrate is put in place during assembly. The sensor may be based on either capacitance or resistance measurements.

### BACKGROUND OF THE INVENTION

The invention relates to touch sensitive sensors, also known as touch screens, and in particular to establishing electrical contact between a sensing element and a sensor circuit in such a sensor.

The use of touch-sensitive sensors is becoming more common. Examples include the use of touch sensors in laptop computers in place of mouse pointing devices and as control panels for receiving user inputs to control a device or appliance, both domestic and portable.

Touch-sensitive sensors are frequently preferred to mechanical devices because they provide a more robust interface and are often considered to be more aesthetically pleasing. In addition, because touch-sensitive sensors require no moving parts to be accessible to a user, they are less prone to wear than their mechanical counterparts and can be provided within a sealed outer surface. This makes their use where there is a danger of dirt or fluids entering a device being controlled particularly attractive. Furthermore, unlike mechanical interfaces, touch sensitive sensors can be made transparent. There is an increasing desire to provide transparent sensors because these can be used over a display to provide a touch sensitive screen which is capable of displaying information to a user and responding to a user pointing to particular areas of the display.

FIG. 1 schematically shows in perspective view a conventional control panel 2 incorporating a capacitance-based touch-sensitive sensor. The control panel 2 comprises a cover panel 8, a sensing element 4 and a circuit board 6. The sensing element 4 and the circuit board 6 are affixed to the underside of the cover panel 8. (The side that is not accessible to a user during normal use is considered the underside).

The sensing element 4 is based on a transparent flexible plastic substrate. The substrate comprises a sensor area 10 and a connector part 12 (also known as a tail connector). A transparent conductive material is deposited on the substrate to provide sensor electrodes 14 and traces 16 for routing signals between the sensor electrodes and the circuit board 6 via the tail connector 12. The traces 16 in a region towards the end of the tail connector 12 are tin plated to provide a connection region 18.

The circuit board 6 carries drive circuitry (not shown) for the sensor electrodes 14 and corresponding calculation circuitry (also not shown) for determining the position of a touch. The drive and calculation circuitry may be collectively referred to as measurement circuitry.

The cover panel 8 is transparent in a region overlaying the sensor area part of the sensing element 4, and opaque over the remainder of its surface. Thus a display screen (not shown) mounted behind the sensing element is visible to a user whereas the circuit board 6 and tail connector part 12 of the sensing area are not.

During assembly of the control panel 2, an electrical connection must be established between the sensing electrodes 14 of the sensing element 4 and the measurement circuitry on the circuit board 6. This is done by inserting the connection region 18 of the tail connector 12 of the sensing element 4 into a socket on the circuit board 6.

FIG. 2A schematically shows a perspective view of the underside of a portion of the circuit board 6 to which a socket 20 is mounted. The socket 20 is a ZIF-line connector of the type provided by Tyco Electronics Corporation. The socket comprises a body part 24 and a sliding cover 26. The body part 24 includes metal contacts 22 which connect through to pins on the base of body part 24 for soldering to the circuit board 6. The socket 20 is shown in its open configuration with the sliding cover 26 extended away from the circuit board 6. In this configuration the socket 20 is ready to receive the connection region 18 of the tail connector 12. To establish connection the connection region 18 is pushed into a slot opening 28 between the body part 24 and the sliding cover 26 (as indicted in FIG. 2A by the direction of the arrow) and the sliding cover 26 is closed.

FIG. 2B is similar to and will be understood from FIG. 2A but shows the socket 20 in its closed configuration with the sliding cover 26 having being pushed towards the circuit board 6 after insertion of the tail connector 12 into the slot opening 28. In the closed configuration the sliding cover 26 presses the connection region 18 of the tail connector 12 against the metal contacts 22 of the socket 20 to establish the required electrical connections and also acts to hold the tail connector in place.

The above described mechanism provides for robust and reliable electrical connections between touch sensing elements and their associated measurement circuitry. However, for high volume production lines, the process of establishing the connection by inserting the tail connector into the socket and closing the sliding cover can be relatively slow to implement and requires relatively complex manipulation making it difficult to automate.

Another known way of connecting a circuit board to a sensing element in a touch sensitive sensing element involves mounting the circuit board in a stand-off relationship with respect to the sensing element, and providing a conductive foam pillar to connect between the circuit board and the sensing element, as shown in DE 201 19 700 U1. However, this approach again requires relatively complex manipulation to position the conductive foam pillars during assembly, and furthermore, the required stand-off relationship means that the circuit board cannot be mounted flush with the sensing element. This not only means that more space is required, but also means the circuit board cannot simply be glued to a cover panel or to the sensing element itself because a stand off mounting is required.

### SUMMARY OF THE INVENTION

According to a first aspect of the invention there is provided a touch-sensitive sensor comprising: a control circuit board having opposing first and second sides; a sensor substrate having a connection terminal; and a resilient electrical connector for establishing an electrical connection between the control circuit board and the connection terminal, wherein the resilient electrical connector is mounted on the first side of the control circuit board and is configured to extend over the edge of the control circuit board and in a direction towards the second side of the circuit board in order to connect with the connection terminal of the sensor substrate.

Thus electrical connection between the control circuit board and the sensor substrate may be established during assembly of the touch-sensitive sensor by simply pressing the control circuit board into position. Furthermore, because there are no electrical connections associated with the second side of the circuit board, this side of the circuit board is able to lie flush with a supporting structure for the board. The supporting structure may, for example, be the sensor substrate itself or a separate cover panel to which the sensor substrate and control circuit board are both attached. This again provides for easy assembly as a simple adhesive layer can be used to mount the circuit board with no “stand-offs” or spacers required to accommodate circuit elements on the side of the control circuit board fixed to the sensor substrate/cover panel.

The resilient electrical connector may be provided in the form of a metal leaf spring. This is a very simple and reliable way of providing a good electrical connection having appropriate resilience and which can be attached to the control circuit board by conventional soldering (manual or automated).

The resilience of the electrical connector helps to ensure a reliable connection with the connection terminal of the sensor substrate. To further improve the reliability of the connections, a portion of the metal leaf spring which connects with the connection terminal of the sensor substrate may be bifurcated.

To further help ensure a good electrical connection and reduce wear/corrosion, the connection terminal of the sensor substrate may comprise a carbon pad.

The resilient electrical connector may be mounted to so as to pass over an outer edge of the control circuit board, or may be mounted to pass over an inner edge, for example an edge of a hole specifically provided for the resilient electrical connector to pass through.

The touch-sensitive sensor may be of any conventional kind, for example the sensing element may be capacitance-based or resistance-based. The touch-sensitive sensor may have a transparent area for overlaying a display screen.

Multiple electrical connections between the control circuit board and the sensor substrate may be established in the same way. For example, the touch sensitive sensor may further comprise at least one further connection terminal on the sensor substrate and at least one further resilient electrical connector mounted on the first side of the control circuit board and configured to extend over the edge of the control circuit board and in a direction towards the second side of the circuit board in order to connect with corresponding ones of the at least one further connection terminal of the sensor substrate.

According to a second aspect of the invention there is provided an apparatus/device incorporating a touch-sensitive sensor according to the first aspect of the invention.

According to a third aspect of the invention there is provided touch-sensitive sensor comprising: a control circuit board; a sensor substrate having a connection terminal; and a resilient electrical connector for establishing an electrical connection between the circuit board and the sensor substrate, wherein the resilient electrical connector includes a projection configured to locate within a corresponding recess in the control circuit board.

Providing the resilient electrical connector with a projection which locates in a corresponding recess of the control circuit board can help to reduce the likelihood of the resilient electrical connector creeping or lifting away from the circuit board during use.

According to a fourth aspect of the invention there is provided an apparatus/device incorporating a touch-sensitive sensor according to the third aspect of the invention.

### BRIEF DESCRIPTION OF THE DRAWINGS

For a better understanding of the invention and to show how the same may be carried into effect reference is now made by way of example to the accompanying drawings in which:

FIG. 1 schematically shows in perspective view a known control panel incorporating a touch-sensitive sensor;

FIGS. 2A and 2B schematically show perspective views a socket connector of the control panel of FIG. 1;

FIG. 3 schematically shows in perspective view a sensing element for use in a control panel having a touch-sensitive sensor according to an embodiment of the invention;

FIG. 4 schematically shows in perspective view a control panel incorporating the sensing element of FIG. 3;

FIG. 5 schematically shows in perspective view a portion of the control panel of FIG. 4 on a magnified scale;

FIGS. 6A and 6B respectively show section views of the portion of the control panel shown in FIG. 5 after and just prior to assembly;

FIG. 7 schematically shows in perspective view a strip of eight resilient electrical connectors for use in the control panel of FIG. 5; and

FIGS. 8A-C schematically show plan, side and front elevations of the strip of resilient electrical connectors shown in FIG. 7.

### DETAILED DESCRIPTION

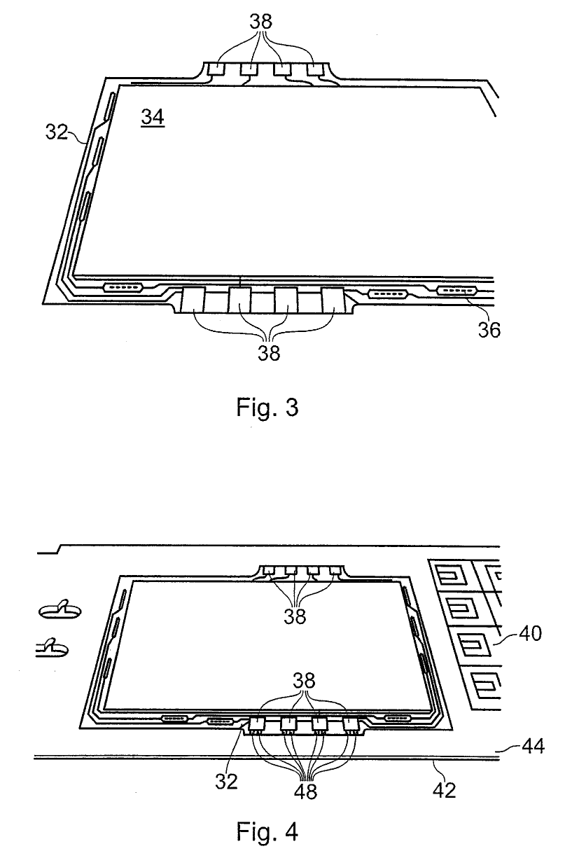

FIG. 3 schematically shows in perspective view a sensing element 32 for use in a touch sensitive sensor according to a first embodiment of the invention. In this example, the sensing element is designed to be employed in a control panel for a domestic dishwasher. The view shown in FIG. 3 is a rear view. “Rear” refers to the side facing away from a user in normal use. Terms such as “in front of” and “behind” should be similarly interpreted.

The sensing element 32 is a capacitive sensing element and comprises a transparent central portion defining a sensor area 34, and a non-transparent perimeter portion 36. The sensing element 32 is formed from a flexible plastic sensor substrate having transparent sensor electrodes deposited thereon (not visible in FIG. 3). The arrangement of sensor electrodes may be conventional, for example discrete sensors or a matrixed array may be used. The sensor electrodes are connected to respective ones of connection terminals 38, in this case eight of them, on the substrate via conductive traces running within the transparent sensor area 34 or the perimeter area 36 as appropriate. The traces, at least the parts of them within the transparent sensor area 34, are also transparent. The connection terminals 38 are provided by carbon pads in connection with the respective conductive traces.

In use the transparent central sensor area 34 overlays a display screen. The display screen presents options to a user which are associated with the operation of the device/apparatus in which the display screen and control panel are incorporated, i.e. in this case a dishwasher. The user selects options by placing his finger (or other object) over the corresponding areas of the screen. The position of the user's finger is determined by the position touch sensitive sensor and the dishwasher responds accordingly.

FIG. 4 schematically shows in front perspective view a control panel 40 in which the sensing element 32 of FIG. 3 is incorporated according to an embodiment of the invention. In addition to the sensing element 32, the control panel 40 comprises a printed circuit board (PCB) 42 and a glass cover panel 44. The PCB is provided with a plurality of electrical connectors 48 for establishing electrical connections between the circuit board and the connection terminals 38 of the sensing element 32. In this example there are two electrical connectors associated with each connection terminal. This redundancy provides for increased reliability. For clarity only the electrical connectors 48 associated with the four connection terminals in the foreground of FIG. 4 are identified by reference numeral. However, similar electrical connectors are associated with the connection terminals in the background of the figure.

The cover panel 44 is uppermost in FIG. 4, but is transparent over its whole area and so is not clearly visible in the Figure. In practice, the cover panel would normally be transparent only over the area of the display screen and opaque elsewhere. This allows the underlying display screen to be visible while the remainder of the interior of the dishwasher is hidden from view during normal use. Furthermore, it is noted in some cases the control panel will not overlay a display screen and so the cover panel 44 may be opaque over its whole surface. In such cases the sensor electrodes and traces of the sensing element 32 can also be non-transparent.

The PCB 42 carries circuitry for driving, and receiving and processing signals from the sensing element 32 so that the occurrence of a touch over the touch sensitive sensor can be identified. This circuitry is collectively referred to here as measurement or control circuitry. The measurement circuitry may be of any conventional type appropriate for the type of sensing element employed. The PCB may also carry circuitry associated with the normal functioning of the dishwasher.

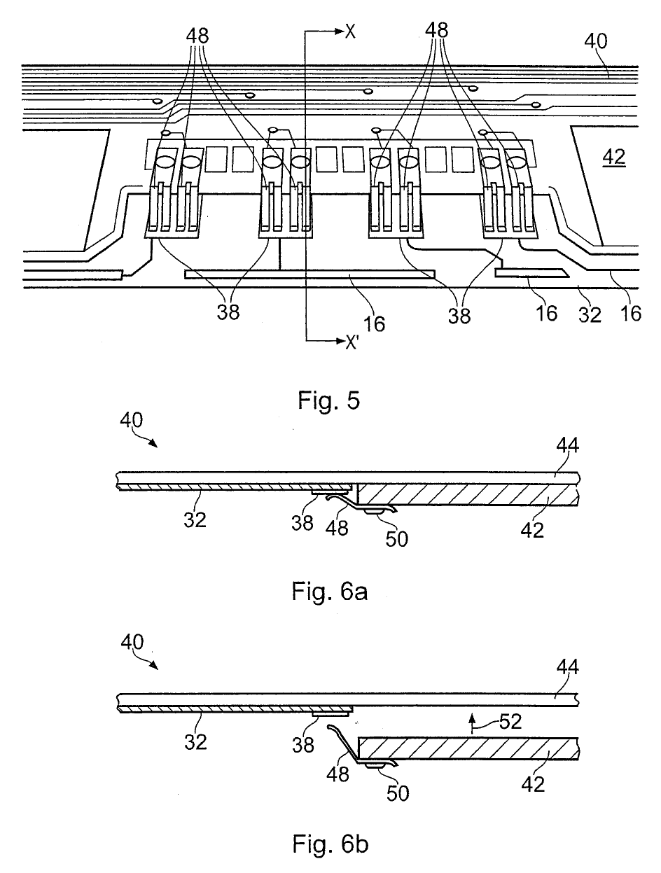

FIG. 5 schematically shows a rear perspective view of a portion of the control panel shown in FIG. 4 on a magnified scale. The portion shown includes four of the connection terminals 38 of the sensing element 32 and the associated resilient (sprung) electrical connectors 48. In this example there are two electrical connectors 48 (i.e. four contact “fingers”) for each connection terminal 38. This can be useful since if one electrical connector 48 (or one of its contact “fingers”) breaks or is misaligned with its corresponding connection terminal (e.g. carbon pad), it is likely that there is a sufficient number of other connection points for a good electrical contact to be established.

FIG. 6A shows a section view of the portion of the control panel 40 shown in FIG. 5 taken along line XX′. The section in FIG. 6A is shown with the front of the control panel 40 (i.e. the side accessible to a user during normal use) uppermost.

The PCB 42 and sensing element 32 are of co-operating shape so that their edges run adjacent to one another in the region of the spring electrical connectors 48. The electrical connectors 48 are fixed to the PCB 42 by soldered joints 50. The electrical connectors are located near an edge of the PCB 42 and arranged to extend over and away from the edge in a direction towards the cover panel 44 (i.e. downwards for the orientation shown in FIG. 5, upwards for the orientation shown in FIG. 6A). Thus the electrical connectors 48 are configured to contact their corresponding connection terminals 38 so that an electrical connection is established between the circuitry on the PCB 42 and the sensor electrodes on the sensing element 32 via the sprung electrical connectors 48.

FIG. 6B is similar to and will be understood from FIG. 6A, but shows the configuration of the control panel 40 during assembly at a point just prior to fixing the PCB 42 to the cover panel 44. At this stage of assembly, the sensing element 32 has been fixed in place on the cover panel 44 using an appropriate adhesive layer. The PCB 42 is being offered up ready to be pressed onto the cover panel, as schematically indicated by the arrow 52. The PCB 42 (and/or the corresponding part of the cover panel 44) is provided with a layer of adhesive so that it will affix to the cover panel when pressed into contract with it.

As can be seen in FIG. 6B, the sprung electrical connector 48 is configured so that prior to assembly the sprung connector extends over the edge of the PCB 42 from one side (the side to which it is soldered (lowermost in FIG. 6B)) to beyond the other side (the side of the PCB to be fixed to the cover panel). Thus as the PCB 42 is pushed towards the cover panel 44 during assembly, the sprung electrical connectors contact the appropriately located connection terminals 38 of the sensing element before the PCB 42 contacts, and becomes fixed to, the cover panel 44. The resilient nature of the sprung electrical connectors 48 mean that they deflect and allow the PCB 42 to continue onwards towards the cover panel 44. Thus when the PCB 42 contacts and adheres to the cover panel, the sprung electrical connectors 48 are resiliently biased against the respective connection terminals 38. This ensures a good electrical contact is established without requiring any additional fixing.

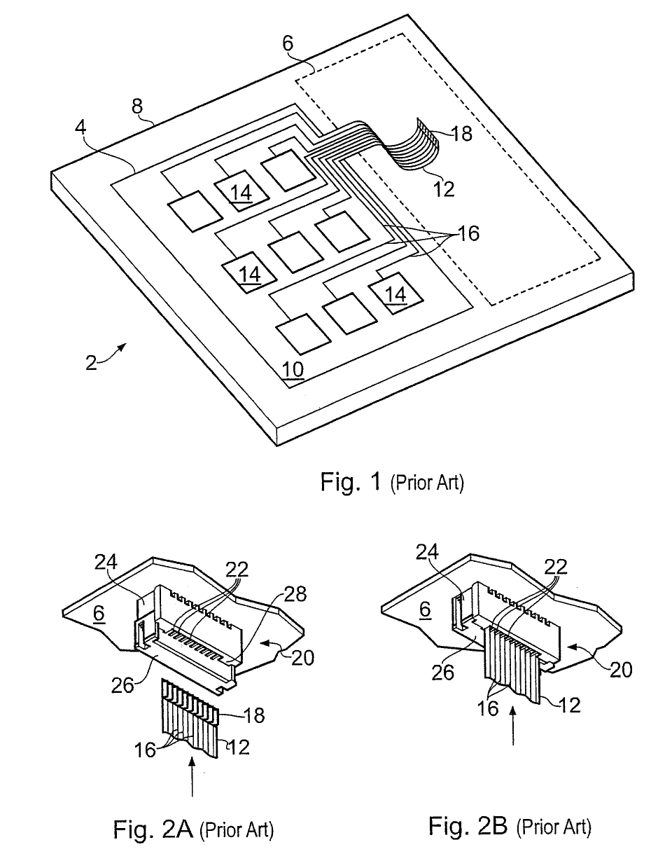

Thus an electrical connection is established simply by pressing the PCB 42 into place without the need for a separate manipulation step for connecting a tail connector to a socket as shown in FIGS. 1, 2A and 2B. Furthermore, by having the electrical connectors extend “backwards” in a direction past the PCB's own thickness, the electrical connection is automatically established without requiring any components or connections on the side of the PCB 42 to be mounted against the cover panel 44. Since the PCB can lie flush with the cover panel it can be affixed using a simple adhesive layer.

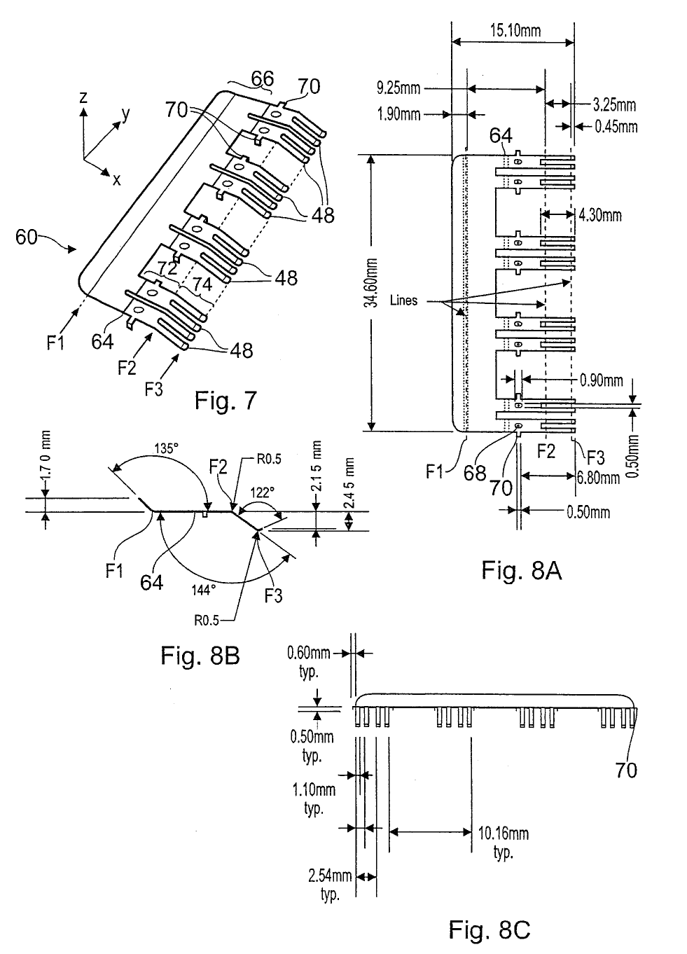

FIG. 7 schematically shows a perspective view of a strip 60 of eight sprung electrical connectors 48 ready for soldering to a PCB as shown in FIG. 5. FIGS. 8A, 8B and 8C schematically show views of the strip 60 taken respectively along Z, Y and X axes as indicated in the above left of FIG. 7. FIGS. 8A, 8B and 8C show dimensions of the strip 60 which might be used in a typical application. It will be appreciated, however, that the sprung electrical connectors of the invention are inherently scaleable and various different sizes and relative shapes may be used.

The strip 60 comprises a disposable backbone portion 66 to which the eight sprung electrical connectors 48 are attached. The backbone portion 66 acts as a stiffener and for holding the electrical connectors in place in one plane on the PCB during assembly and so allows for easy manipulation of the strip of connectors 48. In this example the strip 60 is stamped from a phosphor bronze sheet (optionally plated to reduce corrosion, e.g., preferably with gold or platinum etc.) and bent at lines F1, F2 and F3 (shown as dashed lines in FIGS. 7 and 8A) by the amounts shown in FIG. 8B to provide the desired shape.

Thus, by providing the eight sprung electrical connectors 48 initially as a single strip they are easier to handle during manufacture/assembly. This is because the strip 60 can easily be held by its backbone against the PCB with all of the electrical connectors 48 being positioned in their required locations in a single assembly step. Each electrical connector 48 can then be soldered to appropriately positioned pads on the PCB. The locating of the strip and the soldering may be automated, for example using an infrared re-flow process in a conventional PCB assembly robot. Once the electrical connectors 48 are soldered into place, the disposable backbone 66 can be snapped off leaving the now separated electrical connectors 48 in place. This may be facilitated by providing a fatigue or fracture line 64 at the position where each electrical connector connects to the disposable backbone (tab rail). The fracture line may be provided by scoring/scribing or by partially etching the strip, for example.

Thus each electrical connector 48 in effect comprises a leaf spring having a fixed part 72 for attaching it to the PCB and a free part 74 for extending beyond the edge of the PCB and connecting with the connection terminals 38 of the sensing element 32.

In this example, the respective fixed parts are provided with openings 68 through which liquid solder can flow during manufacture to improve the soldered joint. Furthermore, in this example the fixed parts 72 are provided with tabs 70 which may be bent towards the PCB to enter corresponding recesses in the PCB surface. These tabs provide for an improved mechanical coupling between the electrical connectors 48 and the PCB and reduces the likelihood of the soldered joints separating over time. In the example shown in FIG. 7, the tabs 70 are located on side edges of the fixed parts 72 of the electrical connectors 48. However, in other examples, tabs may be provided in a centre portion of the electrical connectors 48. These tabs may be as well as or in addition to tabs at the side edges such as shown in FIG. 7. For example, tabs may be provided at an inner edge of the openings 68. Thus the opening 68 may be formed not by a complete stamp out, but by a U- or similar-shaped cut such that the centre portion of the U than be bent to provide the tab and also to reveal the opening 68. It may be preferable to locate tabs in a centre region in this way to reduce any susceptibility of failure due to twisting forces. E.g. if only a single tab is to be provided per electrical connector 48, if this tab is along a side edge, there may be an increased chance of the opposing edge separating from the PCB. The chances of either side separating can be reduced by centralising the tab.

The free parts 74 of the electrical connectors 48 are bent at line F2 to angle them towards a plane containing the side of the PCB which is opposite to that of the side of the PCB to which they are attached. Furthermore, each of the free parts 74 is bifurcated (i.e. to provide two contact “fingers”) to provide two contact points which are close to being mechanically independent and to improve contact reliability. Each of the two ends of the bifurcated free part is bent upwards at F3 so that it is the outer face of the bend at F3 which contacts the corresponding connection terminal 38 on the sensing element 32. This provides a connection point which can slide along the surface of the connection terminal 38 as the sprung electrical connectors 48 are flexed during assembly without causing undue damage.

It will be appreciated that although the above-described example implementation concerns establishing electrical connections between a control circuit board and a sensing element in a capacitance-based touch sensitive sensor in a dishwasher, the invention can be used for establishing electrical connections in any kind of apparatus or device having a resistance- or capacitance-based touch sensitive sensor (which may be single or multi-layered, e.g., dual-sided). In all cases the sensing element and the control circuitry on the PCB can be of any conventional type according to the application at hand.

Furthermore, it will be appreciated that the cover panel and the sensing element may be provided as a single element. That is to say, sensor electrodes may be deposited directly on the inside (i.e. the side opposite a user in normal use) of the cover panel, with the appropriate traces and connection terminals also deposited on the inside of the cover panel. Thus this configuration may be considered as one in which in effect there is no cover panel. Instead the substrate of the sensing element itself provides the protective and external aesthetic functions of the cover panel, and the PCB is fixed directly to the sensing element substrate adjacent the connection terminals.

It will also be appreciated that the edge of the PCB adjacent to which the connection terminals of the sensing element are provided need not be an outer edge of the PCB, but may be an interior edge of an opening in the PCB. The opening may be large enough to accommodate the whole of the sensitive area of the sensing element, for example, or may simply be a hole in the PCB large enough for the resilient electrical contact to pass through.

Although particular embodiments of the invention have been described, it will be appreciated that many modifications/additions and/or substitutions may be made without departing from the scope of the invention.

What is claimed is:

1. A touch-sensitive sensor comprising:
a control circuit board having first and second sides;
a sensor substrate having a connection terminal; and
a resilient electrical connector for establishing an electrical connection between the control circuit board and the connection terminal, wherein the resilient electrical connector is mounted on the first side of the control circuit board and is configured to extend over an edge of the control circuit board and in a direction towards the second side of the circuit board in order to connect with the connection terminal of the sensor substrate.

2. A touch-sensitive sensor according to claim 1, wherein the resilient electrical connector is a metal leaf spring.

3. A touch-sensitive sensor according to claim 2, wherein a portion of the metal leaf spring which connects with the connection terminal of the sensor substrate is bifurcated.

4. A touch-sensitive sensor according to claim 1, wherein the resilient electrical connector is mounted to the circuit board by a soldered joint.

5. A touch-sensitive sensor according to claim 1, wherein the resilient electrical connector includes a projection configured to locate within a corresponding recess in the control circuit board to provide a mechanical coupling.

6. A touch-sensitive sensor according to claim 1, wherein the connection terminal of the sensor substrate comprises a carbon pad.

7. A touch-sensitive sensor according to claim 1, wherein the edge is an outer edge of the control circuit board.

8. A touch-sensitive sensor according to claim 1, wherein the edge is an inner edge of an opening in the control circuit board.

9. A touch-sensitive sensor according to claim 1, further comprising a cover panel to which the second side of the control circuit board and the sensor substrate are fixed.

10. A touch-sensitive sensor according to claim 9, wherein the sensor substrate is fixed to the control panel by an adhesive layer.

11. A touch-sensitive sensor according to claim 9, wherein the control circuit board is fixed to the control panel by an adhesive layer.

12. A touch-sensitive sensor according to claim 1, wherein the sensor substrate is a capacitance measurement based sensor substrate.

13. A touch-sensitive sensor according to claim 1, wherein the sensor substrate is a resistance measurement based sensor substrate.

14. A touch-sensitive sensor according to claim 1, wherein at least a part of the sensor substrate is transparent.

15. A touch-sensitive sensor according to claim 1, further comprising at least one further connection terminal on the sensor substrate and at least one further resilient electrical connector mounted on the first side of the control circuit board and configured to extend over the edge of the control circuit board and in a direction towards the second side of the circuit board in order to connect with corresponding ones of the at least one further connection terminal of the sensor substrate.

16. An apparatus including a touch-sensitive sensor according to claim 1.

17. A touch-sensitive sensor comprising:
a control circuit board;
a sensor substrate having a connection terminal; and
a resilient electrical connector for establishing an electrical connection between the circuit board and the sensor substrate, wherein the resilient electrical connector includes a projection configured to locate within a corresponding recess in the control circuit board.

18. A touch-sensitive sensor according to claim 17, further comprising at least one further connection terminal on the sensor substrate, and at least one further resilient electrical connector for establishing an electrical connection between the circuit board and the sensor substrate, wherein the at least one further resilient electrical connector includes a projection configured to locate within a corresponding recess in the control circuit board.

19. An apparatus including a touch-sensitive sensor according to claim 17.
